(19) United States
(12) Patent Application Publication
(10) Pub. No.: US 2021/0398139 A1
(43) Pub. Date: Dec. 23, 2021

(54) METHODS AND DEVICES FOR PROCESSING INFORMATION

(71) Applicant: Beijing Sensetime Technology Development Co., Ltd., Beijing (CN)

(72) Inventors: Mingyang ZHANG, Beijing (CN); Yuting GAO, Beijing (CN)

(21) Appl. No.: 17/466,045

(22) Filed: Sep. 3, 2021

Related U.S. Application Data
(63) Continuation of application No. PCT/CN2020/104516, filed on Jul. 24, 2020.

(30) Foreign Application Priority Data
Aug. 14, 2019 (CN) 201910750560.1

(51) Int. Cl. G06Q 30/00; G06K 9/00; G06K 9/62; G06F 3/0482; G07C 9/38; G06Q 30/02; G06F 9/451; G06F 9/54; G06F 16/532

(52) U.S. Cl. CPC G06Q 30/016; G06K 9/00281; G06K 9/6202; G06K 9/00362; G06K 9/00892; G06K 9/00771; G06Q 10/105; G07C 9/38; G06Q 30/0201; G06F 9/451; G06F 9/542; G06F 16/532; G06F 3/0482

(57) ABSTRACT

Methods, devices, and systems for processing information are disclosed. In one aspect, a method includes: acquiring a visiting image of a visitor in a target place, detecting the visiting image to obtain an identifier of the visitor, acquiring historical visiting information corresponding to the identifier, and sending a visiting notification message to one or more terminals based on the historical visiting information.

### CROSS-REFERENCE TO RELATED APPLICATIONS

The present disclosure is a continuation application of International Application No. PCT/CN2020/104516 filed on Jul. 24, 2020, and claims priority to Chinese patent application No. 201910750560.1, entitled “METHODS, APPARATUSES AND DEVICES FOR PROCESSING INFORMATION” and filed on Aug. 14, 2019, the disclosure of which are incorporated herein by reference in its entirety.

### TECHNICAL FIELD

The present disclosure relates to the field of information processing technologies, and in particular, relates to methods and devices for processing information.

### BACKGROUND

In practice, sales staff in a 4S store tends to serve different customers in different strategies, so as to increase a sales conversion rate and obtain greater benefits. Thus, how to achieve a personalized service for a customer is a hot topic of the related researches.

### SUMMARY

The embodiments of the present disclosure provide solutions for processing information.

In a first aspect, a method of processing information is provided, and the method is performed by a computing device and includes: acquiring a visiting image of a visitor in a target place; detecting the visiting image to obtain an identifier of the visitor; acquiring historical visiting information corresponding to the identifier; and sending a visiting notification message to one or more terminals based on the historical visiting information.

In a second aspect, a method of processing information is provided, and the method is performed by a computer device and includes: receiving, from a server, a visiting notification message on a detected visitor, where the visiting notification message is sent based on historical visiting information corresponding to an identifier of the visitor; and displaying, based on the visiting notification message, a visiting prompt interface about the visitor.

In a third aspect, a system for processing information is provided, and the system includes a first device. The first device includes at least one first processor and at least one non-transitory machine readable storage medium coupled to the at least one first processor having machine-executable instructions stored thereon. The machine-executable instructions, when executed by the at least one first processor, cause the at least one first processor to perform operations including: acquiring a visiting image of a visitor in a target place; detecting the visiting image to obtain an identifier of the visitor; acquiring historical visiting information corresponding to the identifier; and sending a visiting notification message to one or more terminals based on the historical visiting information.

In a fourth aspect, the system further includes a second device. The second device further includes at least one second processor and at least one non-transitory machine readable storage medium coupled to the at least one second processor having machine-executable instructions stored thereon. The machine-executable instructions, when executed by the at least one second processor, cause the at least one second processor to perform operations including: receiving, from the first device, the visiting notification message on the visitor; and displaying, based on the visiting notification message, a visiting prompt interface about the visitor.

It should be understood that the above general description and the following detailed description are only exemplary and explanatory, and are not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a flowchart illustrating a method of processing information according to an example of the present disclosure.

FIG. 2 is a flowchart illustrating a method of obtaining an identifier of a visitor according to an example of the present disclosure.

FIG. 3 is a flowchart illustrating another method of obtaining an identifier of a visitor according to an example of the present disclosure.

FIG. 4 is a flowchart illustrating a method of binding a visitor with a terminal user according to an example of the present disclosure.

FIG. 5 is a flowchart illustrating another method of processing information according to an example of the present disclosure.

FIG. 6 is a schematic diagram illustrating an information interface about a visitor according to an example of the present disclosure.

FIG. 7 is a flowchart illustrating another method of processing information according to an example of the present disclosure.

FIG. 8 is a schematic structural diagram illustrating an apparatus for processing information according to an example of the present disclosure.

FIG. 9 is a schematic structural diagram illustrating another apparatus for processing information according to an example of the present disclosure.

FIG. 10 is a structural diagram illustrating a device for processing information according to an example of the present disclosure.

FIG. 11 is a structural diagram illustrating another device for processing information according to an example of the present disclosure.

### DETAILED DESCRIPTION OF THE EMBODIMENTS

Exemplary embodiments will be described in detail here with the examples thereof expressed in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

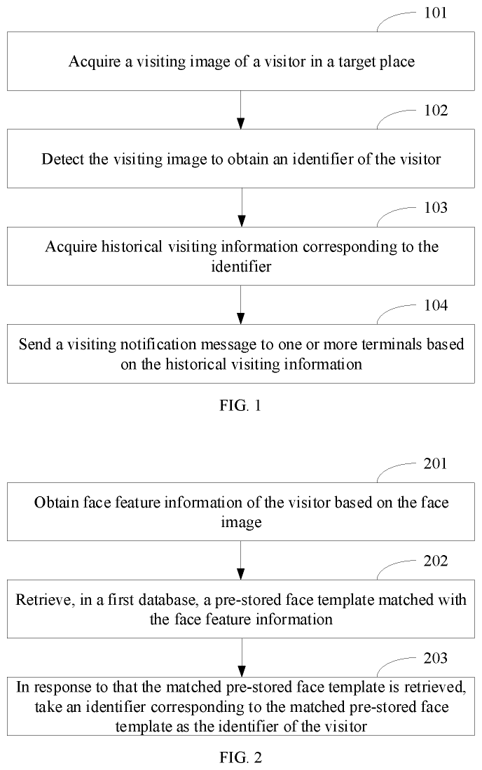

FIG. 1 is a schematic flowchart illustrating a method of processing information according to an example of the present disclosure. A party that performs the method may be a server, such as a cloud server. As shown in FIG. 1, the method includes the following steps.

At step 101, a visiting image of a visitor in a target place is acquired.

The visiting image of the visitor may be captured by an image capturing device, such as a camera and a pick-up head.

In some examples, the captured visiting image may be acquired by the image capturing device in real time, at a certain time interval, or at a certain frame interval. Then, the server obtains the visiting image from the image capturing device.

In some examples, the visiting image obtained by the server may have been processed by the image capturing device.

In some examples of the present disclosure, there may be one or more image capturing devices having respective known locations and respective preset capturing areas. In some examples, they are arranged at different positions of the target place to cover the target place as completely as possible.

The visiting image may include a face image or a body image, or include both the face image and the body image.

At step 102, the visiting image is detected to obtain an identifier of the visitor.

By detecting the visiting image, feature information of the visitor, which is contained in the visiting image, is obtained. Based on the feature information, it is to retrieve in a database of the server to obtain the identifier corresponding to the feature information of the visitor. The specific method of obtaining the identifier of the visitor will be detailed in later description.

At step 103, historical visiting information corresponding to the identifier is acquired.

In some examples of the present disclosure, the historical visiting information corresponding to each identifier is stored in the database of the server. The historical visiting information may include at least one of the following information items of the visitor to which the identifier belongs: a number of visits to a certain store, a visiting time of each visit, a stay duration of each visit, interested product(s) of each visit, a reference image, a name, contact details, a visiting frequency, tagged information, or the like.

At step 104, a visiting notification message is sent to one or more terminals based on the historical visiting information.

The visiting notification message may include: the identifier of the visitor, a captured time of the visiting image, and label information of the visitor.

The label information may be generated from the historical visiting information of the visitor, and may include any one or more items of the historical visiting information. Those skilled in the art should understand that the label information may also be generated in other ways and may include other information, which is not limited in the examples of the present disclosure.

The visiting notification message may also include information about a terminal user bound with the identifier of the visitor. For example, when a certain terminal user is responsible for serving the visitor, it is to prompt the terminal user to pay attention to a current visit of the visitor. The terminal user includes, but is not limited to, service staff, sales staff, or the like.

According to some examples of the present disclosure, by detecting a visiting image of a visitor to obtain an identifier of the visitor and historical visiting information corresponding to the identifier, and sending a visiting notification message to one or more terminals based on the historical visiting information, a terminal user can obtain information about the visitor more accurately and efficiently, so as to provide sales staff with better guidance and then improve their work efficiency, and improve a visiting experience of the visitor.

In some examples, the historical visiting information corresponding to the identifier is acquired in response to that the visitor is detected for a first time within a preset time period.

The first-time detection within the preset time period indicates that the visitor appears within the target place for the first time within the preset time period. Therefore, the visiting notification information is sent to a terminal in response to the first-time detection, which helps the terminal user to provide the visitor with a more timely and efficient service.

For any visitor, however, he may be detected for multiple times in various visiting images because he may walk around. Therefore, it may not send the visiting notification information to the terminal when it is not for the first time that the visitor is detected within the preset time period.

The preset time period, for example, can be set according to corresponding industry characteristics or actual requirements, such as 3 hours, 6 hours, 12 hours, 24 hours, or a natural day, which is not limited in the present disclosure. Taking 24 hours as an example of the preset time period, the visiting notification message is sent to the terminal when the visitor is detected for the first time within 24 hours, while the visiting notification message may not be sent when it is not for the first time that the visitor is detected within 24 hours.

In some examples, the visiting notification message may be sent to the terminal, whose user is bound with the identifier of the visitor, in response to that the current visit of the visitor is indicated as a re-visiting to the target place by the historical visiting information.

The re-visiting means that the number of visits in the historical visiting information is not zero, that is, the current visit of the visitor is a non-initial visit. In this case, the visiting notification message may be sent to the terminal, whose user is bound with the identifier of the visitor, to prompt the terminal user who has ever served and been bound with the visitor to provide a service for the visitor.

In some examples of the present disclosure, for a visitor who visits again, by sending the visiting notification message directly to the terminal, whose user is bound with the identifier of the visitor, it is realized that a targeted prompt is sent to the terminal user who has been associated with the visitor, which can achieve a more efficient and personalized service for a customer.

In some examples, the visiting notification message may be sent to all the terminals in the target place in response to that the current visit of the visitor is indicated as an initial visit to the target place by the historical visiting information.

By means of some examples, in the case of the initial visit of the visitor, the visitor has usually not been bound with a certain terminal user. Moreover, in the case of the re-visiting of the visitor, it is still possible that the visitor has not been bound with a certain terminal user due to various reasons. Therefore, the visiting notification message may be sent to all the terminals in the target place as long as no terminal user bound with the visitor is detected.

Further, the visiting notification message may be sent to at least part of all the terminals in the target place. In particular, the visiting notification message may be sent to different parts of all the terminals based on different terminal selecting criteria. For example, by detecting a relative positional relationship between the visitor and the terminal users holding the terminals, the visiting notification message may be pushed to the terminals whose users are within a range of a preset radius from the visitor. As another example, by detecting a current working status for each terminal user in the target place, the visiting notification message may be pushed to the terminals whose users are idle, i.e., are not serving any visitor at this time. Those skilled in the art should understand that the terminal selecting criteria may be set based on requirements, and the set terminal selecting criteria may be applied individually or as a combination thereof, so as to serve a customer more efficiently.

In some examples, the visiting image may include a face image. As illustrated in FIG. 2, the visiting image includes the face image, and that, accordingly, the visiting image is detected to obtain the identifier of the visitor may include the following steps.

At step 201, face feature information of the visitor is obtained based on the face image.

In an example, the face feature information of the face image may be extracted through a feature extracting network, such as a convolutional neural network. The examples of the present disclosure do not trend to limit a specific structure of the feature extracting network.

In another example, the face feature information of the face image may be obtained from other device, for example, by receiving the face feature information sent by said other device, which is not limited in the examples of the present disclosure.

At step 202, it is to retrieve, in a first database, a pre-stored face template matched with the face feature information.

In the first database, at least respective face templates of past visitors are pre-stored, and the face templates of sales staff may also be pre-stored. In the first database, the face templates of other persons may also be included, which is not limited in the examples of the present disclosure.

In some examples of the present disclosure, the face template may include at least one of the face feature information and the face image.

By retrieving in the first database based on the face feature information, it is to determine whether the face template matched with the face feature information is pre-stored in the first database.

At step 203, in response to that the matched pre-stored face template is retrieved, an identifier corresponding to the matched pre-stored face template is taken as the identifier of the visitor.

In some examples, the first database may store pre-stored face templates and identifiers in a one-to-one correspondence. Thus, a matching is performed between the face feature information with the pre-stored face templates in the first database after the face feature information is obtained, and the identifier corresponding to a certain pre-stored face template is obtained and taken as the identifier of the visitor after the face feature information is successfully matched with the pre-stored face template.

By means of some examples, when a matching degree of the face feature information with respect to a certain pre-stored face template is greater than or equal to a threshold, it is determined that the face feature information is successively matched with the pre-stored face template, so that the matched pre-stored face template is retrieved.

In some examples, in response to that no matched pre-stored face template is retrieved, an identifier is assigned to the visitor, and at least one of the face image and the face feature information is added into the first database as a face template.

In particular, a matching is performed between the face feature information and the pre-stored face templates in the server, and it is determined that no identifier corresponding to the face feature information is stored in the first database when the face feature information fails to be matched with each pre-stored face template. Then, one corresponding identifier is assigned to the face feature information as the identifier of the visitor showed in the visiting image. In addition, at least one of the face image and the face feature information is taken as the face template, and is added into the first database together with the corresponding identifier.

By means of some examples, when the matching degree of the face feature information with respect to each pre-stored face template is less than the threshold, it is determined that the face feature information fails to be matched with each pre-stored face template, so that no matched pre-stored face template is retrieved.

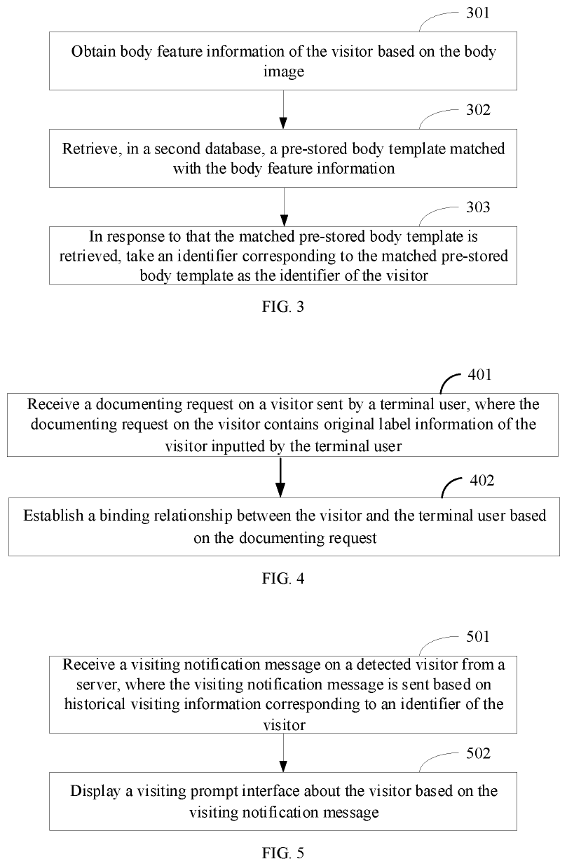

In some examples, the visiting image may include a body image. As illustrated in FIG. 3, the visiting image includes the body image, and that, accordingly, the visiting image is detected to obtain the identifier of the visitor may include the following steps.

At step 301, body feature information of the visitor is obtained based on the body image.

In an example, the body feature information of the body image may be extracted through a feature extracting network, such as a convolutional neural network. The examples of the present disclosure do not trend to limit a specific structure of the feature extracting network.

In another example, the body feature information of the body image may be obtained from other device, for example, by receiving the body feature information sent by said other device, which is not limited in the examples of the present disclosure.

By means of some examples, a body feature may include a static body feature and/or a dynamic action feature, which is not limited in the examples of the present disclosure.

At step 302, it is to retrieve, in a second database, a pre-stored body template matched with the body feature information.

In the second database, at least respective body templates of past visitors are pre-stored, and the body templates of sales staff may also be pre-stored. In the second database, the body templates of other persons may also be included, which is not limited in the examples of the present disclosure.

In some examples of the present disclosure, the body template may include at least one of the body feature information and the body image.

By retrieving in the second database based on the body feature information, it is to determine whether the body template matched with the body feature information is pre-stored in the second database.

At step 303, in response to that the matched pre-stored body template is retrieved, an identifier corresponding to the matched pre-stored body template is taken as the identifier of the visitor.

In some examples, the second database may store pre-stored body templates and identifiers in a one-to-one correspondence. Thus, a matching is performed between the body feature information with the pre-stored body templates in the second database after the body feature information is obtained, and the identifier corresponding to a certain pre-stored body template is obtained and taken as the identifier of the visitor after the body feature information is successfully matched with the pre-stored body template.

By means of some examples, when a matching degree of the body feature information with respect to a certain pre-stored body template is greater than or equal to a threshold, it is determined that the body feature information is successively matched with the pre-stored body template, so that the matched pre-stored body template is retrieved.

In some examples, in response to that no matched pre-stored body template is retrieved, an identifier is assigned to the visitor, and at least one of the body image and the body feature information is added into the second database as a body template.

In particular, a matching is performed between the body feature information and the pre-stored body templates in the server, and it is determined that no identifier corresponding to the body feature information is stored in the second database when the body feature information fails to be matched with each pre-stored body template. Then, one corresponding identifier is assigned to the body feature information as the identifier of the visitor. In addition, at least one of the body image and the body feature information is taken as the body template, and is added into the second database together with the corresponding identifier.

By means of some examples, when the matching degree of the body feature information with respect to each pre-stored body template is less than the threshold, it is determined that the body feature information fails to be matched with each pre-stored body template, so that no matched pre-stored body template is retrieved.

In some examples, the visiting image includes a face image and a body image matched with the face image. When the body image meets a set condition, that is, the body image is clear and complete enough to be detected, the identifier of the visitor is obtained based on the body image. When the body image doesn't meet the set condition, that is, the body image is not clear or complete enough, the identifier of the visitor is obtained based on the face image. The detailed method of obtaining the identifier of the visitor based on the face image or the body image refers to the above description.

In some examples, the historical visiting information corresponding to the identifier is updated based on the current visit of the visitor.

In an example, in the case that the current visit of the visitor is the first visit within the preset time period, for example, the first visit within a natural day, the historical visiting information is updated by increasing its number of visits by one.

In an example, when the current visit of the visitor is the non-first visit within the preset time period, for example, it is not for the first time for the visitor to visit the target place within a natural day, the historical visiting information is not updated, that is, the number of visits is remained unchanged.

By sending the number of visits of the visitor to the terminal, the terminal user can better analyze a purchase intention of the visitor, thereby providing more personalized services.

In some examples, it may also to detect whether the visitor is a target person based on the identifier of the visitor. The target person may include a person who is blacklisted by any target place.

In the case that the visitor is determined to be the target person, the visiting notification message sent to the terminal may include position information of the target person, so that the terminal user can find the target person as soon as possible and take accordingly treatments.

The position information of the target person may be obtained from the visiting image. For example, the position information of the visitor may be obtained based on a location of the image capturing device for capturing the visiting image or based on the preset capturing area. The position information may be tagged in the visiting image.

According to at least one example the present disclosure, a method of binding a visitor with a terminal user is provided. As shown in FIG. 4, the method includes the following steps.

At step 401, a documenting request on a visitor sent by a terminal user is received. The documenting request on the visitor contains original label information of the visitor inputted by the terminal user.

At step 402, a binding relationship is established between the visitor and the terminal user based on the documenting request.

The documenting request is sent by the terminal user through his terminal. The initial label information may include some information about the visitor obtained by the terminal user, such as a name, contact information, and consumption habits. After being bound with the visitor, the terminal user can receive the visiting notification message as soon as the visitor visits.

By binding the visitor with the terminal user, the visiting notification message on the visitor can be sent directly to the associated terminal user, so that a customer can be provided with more efficient and personalized services.

In some examples, the method may further include that for any detected visitor, his stay information is determined based on capturing time and capturing locations of image capturing device's capturing operations, and includes his identifier, his stay duration and his stay position.

In the foregoing examples, there may be one or more image capturing devices in the target place, each of which has a preset capturing area. When the visitor enters the preset capturing area of a certain image capturing device, the image capturing device may captures images of the visitor. Therefore, the stay duration of the visitor in each capturing area may be determined based on the capturing time and the preset capturing area of the respective image capturing device.

By means of some examples, different products are arranged at respective capturing areas, i.e., stay positions. Then, for the visitor, his stay duration aiming at a certain product may be obtained based on his stay duration at the corresponding stay position, so as to determine whether the visitor is interested in the product. Thus, interested product information of the visitor may be obtained based on his stay positions and respective stay durations within the preset time period.

For example, an image capturing device includes five pick-up heads whose corresponding preset capturing areas are area A, area B, area C, area D, and area E, respectively. Different products are arranged individually at area B, area C, area D, and area E. Assuming that a visitor is detected for the first time by the pick-up head for area A at 10:00:00, and is detected as being at area B by the pick-up head for area B from 10:05:00 to 10:15:00 and being at area D by the pick-up head for area D from 10:16:00 to 10:30:00, it may be concluded that his stay duration at area B is 10 minutes and his stay duration at area D is 14 minutes, that is, the visitor pays more attention to or tends to buy products in area B and area D.

According to at least one example of the present disclosure, a method of processing information is provided. As shown in FIG. 5, the method includes the following steps.

At step 501, a visiting notification message on a detected visitor is received from a server, where the visiting notification message is sent based on historical visiting information corresponding to an identifier of the visitor.

At step 502, a visiting prompt interface about the visitor is displayed based on the visiting notification message.

The visiting prompt interface includes the identifier of the visitor, a visiting time of the visitor, and label information of the visitor. The label information may be generated based on the historical visiting information of the visitor, and may include any one or more items of the historical visiting information.

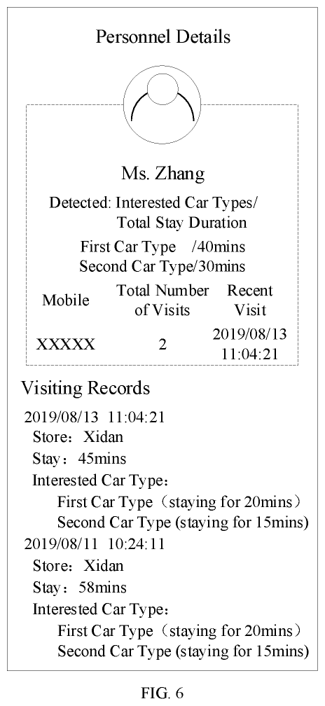

By means of some examples, taking an instance of visiting a 4S car store, the visiting prompt interface, which displays information about the visitor on a terminal, may be illustrated in FIG. 6. The information about the visitor displayed on the visiting prompt interface includes Name, Photo, Contact Details, stay durations, stay-at car types, a number of visits, visiting records, and the like.

Those skilled in the art can understand that the described order of various steps in the above method examples does not mean a strict execution order so as not to constitute any limitation on an implementation process. The specific execution order of various steps should be determined based on their function and any possible inherent logic.

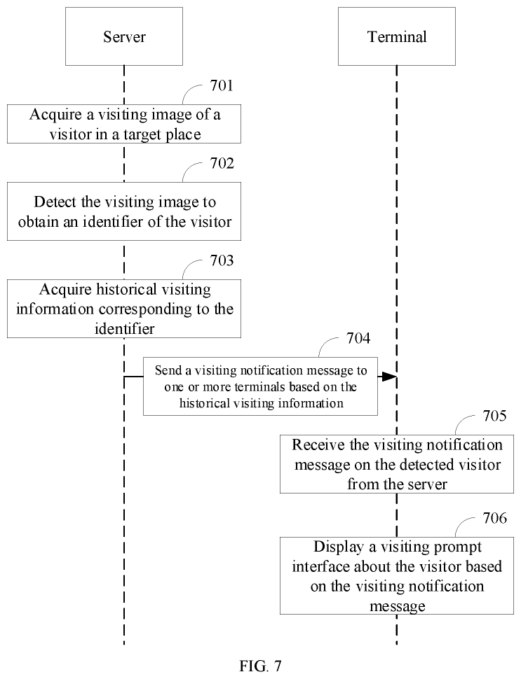

FIG. 7 illustrates a method of processing information according to at least one example of the present disclosure, and the method includes:

at step 701, a server acquires a visiting image of a visitor in a target place;

at step 702, the server detects the visiting image to obtain an identifier of the visitor;

at step 703, the server acquires historical visiting information corresponding to the identifier;

at step 704, the server sends a visiting notification message to one or more terminals based on the historical visiting information corresponding to the identifier;

at step 705, the one or more terminals receive the visiting notification message on the detected visitor from the server; and

at step 706, the one or more terminals display a visiting prompt interface about the visitor based on the visiting notification message.

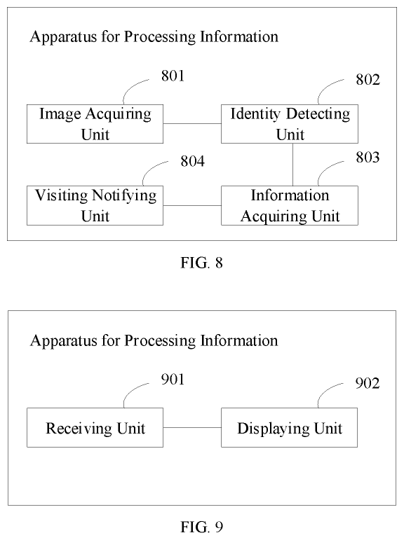

According to FIG. 8, an apparatus for processing information is provided. As illustrated in FIG. 8, the apparatus may include:

an image acquiring unit 801, configured to acquire a visiting image of a visitor in a target place;

an identity detecting unit 802, configured to detect the visiting image to obtain an identifier of the visitor;

an information acquiring unit 803, configured to acquire historical visiting information corresponding to the identifier; and

a visiting notifying unit 804, configured to send a visiting notification message to one or more terminals based on the historical visiting information corresponding to the identifier.

In some examples, the information acquiring unit 803 is specifically configured to: acquire the historical visiting information corresponding to the identifier in response to that the visitor is detected for a first time within a preset time period.

In some examples, the visiting notifying unit 804 is specifically configured to: send the visiting notification message to a terminal whose user is bound with the identifier of the visitor in response to the historical visiting information indicating that a current visit of the visitor is a re-visiting to the target place.

In some examples, the visiting notification message includes: the identifier of the visitor, a captured time of the visiting image, and label information of the visitor.

In some examples, the visiting notification message includes information about the terminal user with whom the identifier of the visitor is bound for prompting the terminal user to pay attention to the current visit of the visitor.

In some examples, the visiting notifying unit 804 is specifically configured to: send the visiting notification message to all terminals in the target place or at least a part thereof in response to the historical visiting information indicating that the current visit of the visitor is an initial visit to the target place.

In some examples, the visiting image includes a face image. Accordingly, the identity detecting unit 802 is specifically configured to: obtain face feature information of the visitor based on the face image; retrieve, in a first database, a pre-stored face template matched with the face feature information; and take an identifier corresponding to the matched pre-stored face template as the identifier of the visitor in response to that the matched pre-stored face template is retrieved.

In some examples, the identity detecting unit 802 is further configured to: assign an identifier to the visitor in response to that no matched pre-stored face template is retrieved; and add at least one of the face image and the face feature information into the first database as a face template.

In some examples, the visiting image includes a body image. Accordingly, the identity detecting unit 802 is specifically configured to: obtain body feature information of the visitor based on the body image; retrieve, in a second database, a pre-stored body template matched with the body feature information; and take an identifier corresponding to the matched pre-stored body template as the identifier of the visitor in response to that the matched pre-stored body template is retrieved.

In some examples, the identity detecting unit 802 is further configured to: assign an identifier to the visitor in response to that no matched pre-stored body template is retrieved; and add at least one of the body image and the body feature information into the second database as a body template.

In some examples, the visiting image includes a face image and a body image matched with the face image. Accordingly, the identity detecting unit 802 is specifically configured to: obtain the identifier of the visitor based on the body image if the body image meets a set condition; and/or, obtain the identifier of the visitor based on the face image in response to that the body image does not meet the set condition.

In some examples, the apparatus further includes an updating unit that is configured to update the historical visiting information corresponding to the identifier based on the information on the current visit of the visitor.

In some examples, the updating unit is specifically configured to: increase the number of visits in the historical visiting information by one in response to the historical visiting information indicating that the current visit of the visitor is a first visit within the preset time period; and/or perform no update on the historical visiting information in response to that the current visit of the visitor is a non-first visit within the preset time period.

In some examples, the apparatus further includes: a target determining unit that is configured to detect whether the visitor is a target person based on the identifier of the visitor. In the case that the visitor is the target person, the visiting notification message includes position information of the target person.

In some examples, the apparatus further includes: a documenting unit that is configured to receive a documenting request on the visitor that is sent by the terminal user through his terminal; and bind the visitor with the terminal user based on the documenting request. The documenting request on the visitor includes initial label information of the visitor that is inputted by the terminal user.

FIG. 9 illustrates an apparatus for processing information according to at least one example of the present disclosure. As illustrated in FIG. 9, the apparatus may include: a receiving unit 901 that is configured to receive, from a server, a visiting notification message on a detected visitor, where the visiting notification message is sent based on historical visiting information corresponding to an identifier of the visitor; and a displaying unit 902 that is configured to display, based on the visiting notification message, a visiting prompt interface about the visitor.

In some examples, the visiting prompt interface includes the identifier of the visitor, a visiting time of the visitor, and label information of the visitor.

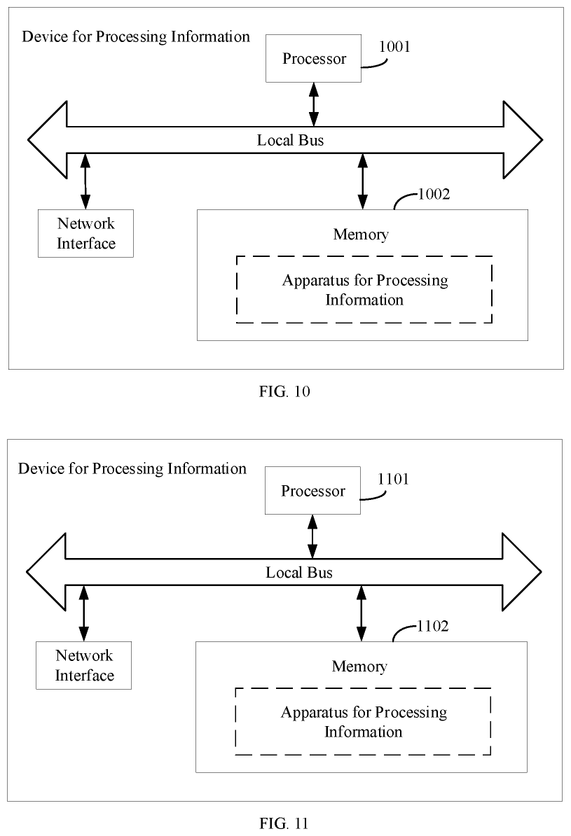

FIG. 10 illustrates a device for processing information provided according to at least one example of the present disclosure. The device includes a memory 1002 and a processor 1001. The memory 1002 is configured to store computer instructions executable on the processor 1001. By executing the computer instructions, the processor 1001 is configured to implement the method of processing information that is applicable in a cloud according to any one example of the present disclosure.

FIG. 11 illustrates a device for processing information provided according to at least one example of the present disclosure. The device includes a memory 1102 and a processor 1101. The memory 1102 is configured to store computer instructions executable on the processor 1101. By executing the computer instructions, the processor 1101 is configured to implement the method of processing information that is applicable in a terminal according to any one example of the present disclosure.

According to at least one example of the present disclosure, a computer-readable storage medium having a computer program stored thereon is provided. When the program is executed by a processor, the method of processing information that is applicable in a cloud according to any one example of the present disclosure is implemented, and/or the method of processing information that is applicable in a terminal according to any one example of the present disclosure is implemented.

In some examples of the present disclosure, the computer-readable storage medium may be in various forms. In different examples, for instance, the machine-readable storage medium may be: random access memory (RAM), volatile memory, non-volatile memory, flash memory, storage drive such as a hard drive, a solid state hard disk, a storage disk of any type such as an optical disk or a DVD, a similar storage medium or a combination thereof. In particular, the computer-readable medium may also be a paper or other suitable medium capable of printing programs. By adopting these media, these programs may be obtained in an electronic form such as an optical scanning, may be compiled, interpreted, and processed in a suitable manner, and then may be stored in the computer media.

According to at least one example of the present disclosure, a computer program product having a computer program or instructions is provided. When executed on a computer, the computer program or the instructions make the computer perform the method of processing information that is applicable in a cloud or in a terminal.

Any example of the present disclosure may be implemented in whole or in part by software, hardware, firmware, or any combination thereof. When implemented by software, it can be implemented in a form of a computer program product in whole or in part. The computer program product includes one or more computer instructions. When the computer program instructions are loaded and executed on the computer, the procedures or functions described in the examples of the present disclosure are generated in whole or in part. The computer may be a general-purpose computer, a special-purpose computer, a computer network, or another programmable device. The computer instructions may be stored in a computer-readable storage medium or transmitted through the computer-readable storage medium. The computer instructions may be transmitted from a website, a computer, a server, or a data center to other website, computer, server, or data center in a wired way such as coaxial cable, optical fiber, and digital subscriber line (DSL), or in a wireless way such as infrared, wireless, and microwave.

The above descriptions illustrate only preferred examples of the present disclosure and do not intend to limit the present disclosure. Any modification, equivalent replacement, improvement and the like made within the spirit and principle of the present disclosure shall be included within the protection scope of the present disclosure.

1. A method of processing information performed by a computing device, the method comprising:
acquiring a visiting image of a visitor in a target place;
detecting the visiting image to obtain an identifier of the visitor;
acquiring historical visiting information corresponding to the identifier; and
sending a visiting notification message to one or more terminals based on the historical visiting information.

2. The method of claim 1, wherein acquiring the historical visiting information corresponding to the identifier comprises:
in response to determining that the visitor is detected for a first time within a preset time period, acquiring the historical visiting information corresponding to the identifier.

3. The method of claim 1, wherein sending the visiting notification message to the one or more terminals based on the historical visiting information comprises one of:
in response to the historical visiting information indicating that a current visit of the visitor is an initial visit to the target place, sending the visiting notification message to at least part of all terminals in the target place; or
in response to the historical visiting information indicating that the visitor is revisiting the target place, sending the visiting notification message to a terminal with which the identifier is bound.

4. The method of claim 1, wherein the visiting notification message comprises: the identifier, a captured time of the visiting image, and label information of the visitor.

5. The method of claim 1, wherein the visiting notification message comprises information about a terminal user with whom the identifier is bound for prompting the terminal user to pay attention to a current visit of the visitor.

6. The method of claim 1, wherein the visiting image comprises a face image, and
wherein detecting the visiting image to obtain the identifier of the visitor comprises:
obtaining face feature information of the visitor based on the face image;
retrieving, in a first database, a pre-stored face template matched with the face feature information; and
in response to retrieving the matched pre-stored face template, taking a second identifier corresponding to the matched pre-stored face template as the identifier of the visitor.

7. The method of claim 1, wherein the visiting image comprises a face image, and wherein detecting the visiting image to obtain the identifier of the visitor further comprises:
obtaining face feature information of the visitor based on the face image,
in response to determining that no matched pre-stored face template is retrieved, assigning a particular identifier to the visitor as the identifier of the visitor, and
adding at least one of the face image or the face feature information into the first database as a face template.

8. The method of claim 1, wherein the visiting image comprises a body image, and
wherein detecting the visiting image to obtain the identifier of the visitor comprises:
obtaining body feature information of the visitor based on the body image;
retrieving, in a second database, a pre-stored body template matched with the body feature information; and
in response to retrieving the matched pre-stored body template, taking a third identifier corresponding to the matched pre-stored body template as the identifier of the visitor.

9. The method of claim 1, wherein the visiting image comprises a body image, and wherein detecting the visiting image to obtain the identifier of the visitor further comprises:
obtaining body feature information of the visitor based on the body image;
in response to determining that no matched pre-stored body template is retrieved, assigning a particular identifier to the visitor as the identifier of the visitor, and
adding at least one of the body image or the body feature information into the second database as a body template.

10. The method of claim 1, wherein the visiting image comprises a face image and a body image matched with the face image, and
wherein detecting the visiting image to obtain the identifier of the visitor comprises one of:
in response to determining that the body image meets a set condition, obtaining the identifier based on the body image; or
in response to determining that the body image does not meet the set condition, obtaining the identifier based on the face image.

11. The method of claim 1, further comprising:
updating the historical visiting information based on information of a current visit of the visitor,
wherein the information of the current visit of the visitor comprises a stay duration of the current visit and a stay position of the current visit, and
wherein the historical visiting information comprises at least one of: a number of visits, a visiting frequency, a stay duration of each visit, or a position of each visit.

12. The method of claim 11, wherein updating the historical visiting information comprises one of:
in response to the historical visiting information indicating that the current visit of the visitor is a first visit within a preset time period, increasing a number of visits in the historical visiting information by one; or
in response to determining that the current visit of the visitor is a non-first visit within the preset time period, performing no update on the historical visiting information.

13. The method of claim 1, further comprising:
detecting whether the visitor is a target person based on the identifier; and
in response to detecting that the visitor is the target person, generating the visiting notification message that comprises position information of the target person.

14. The method of claim 1, further comprising: establishing a binding relationship between the identifier and a terminal user by
receiving, from the terminal user, a documenting request on the visitor, the documenting request comprising initial label information of the visitor that is inputted by the terminal user; and
binding the identifier with the terminal user based on the documenting request.

15. A method of processing information performed by a computing device, the method comprising:
receiving, from a server, a visiting notification message on a detected visitor, wherein the visiting notification message is sent based on historical visiting information corresponding to an identifier of the detected visitor; and
displaying, based on the visiting notification message, a visiting prompt interface about the detected visitor.

16. The method of claim 15, wherein the visiting prompt interface comprises one or more information items of the detected visitor that comprise: identifier information, visiting time information, label information, a base database image, a captured image, and historical visiting information, and
wherein the label information comprises at least a level label, an interest label, or a visiting frequency label.

17. The method of claim 15, wherein displaying the visiting prompt interface about the visitor comprises:
displaying the visiting prompt interface within an application, wherein the visiting prompt interface comprises a visiting notification list, and
wherein the method further comprises:
in response to receiving a trigger operation on one visiting notification in the visiting notification list, displaying detailed personnel information of the visitor corresponding to the visiting notification, wherein the detailed personnel information comprises interest information and stay duration information which are both obtained through counting historical visiting records of the visitor.

18. The method of claim 15, wherein the method is applicable to a terminal, and
wherein displaying the visiting prompt interface about the visitor comprises:
displaying the visiting prompt interface on a locked screen of the terminal.

19. A system for processing information, comprising a first device, wherein the first device comprises:
at least one first processor; and
at least one non-transitory machine readable storage medium coupled to the at least one first processor having machine-executable instructions stored thereon that, when executed by the at least one first processor, cause the at least one first processor to perform operations comprising:
acquiring a visiting image of a visitor in a target place;
detecting the visiting image to obtain an identifier of the visitor;
acquiring historical visiting information corresponding to the identifier; and
sending a visiting notification message to one or more terminals based on the historical visiting information.

20. The system of claim 19, further comprising a second device, wherein the second device comprises:
at least one second processor; and
at least one non-transitory machine readable storage medium coupled to the at least one second processor having machine-executable instructions stored thereon that, when executed by the at least one second processor, cause the at least one second processor to perform operations comprising:
receiving, from the first device, the visiting notification message on the visitor; and
displaying, based on the visiting notification message, a visiting prompt interface about the visitor.
